(19) United States
(12) Patent Application Publication
(10) Pub. No.: US 2009/0118119 A1
(43) Pub. Date: May 7, 2009

(54) WATER GAS SHIFT CATALYST

(75) Inventors: Chandra Ratnasamy, Louisville, KY (US); Jon P. Wagner, Louisville, KY (US)

Correspondence Address: SCOTT R. COX;LYNCH, COX, GILMAN & MAHAN, P.S.C., 500 WEST JEFFERSON STREET, SUITE 2100, LOUISVILLE, KY, 40202, US

(73) Assignee: SUD-CHEMIE INC., Louisville, KY (US)

(21) Appl. No.: 11/933,535

(22) Filed: Nov. 1, 2007

(51) Int. Cl. C01B 3/38; B01J 21/02; B01J 21/06; B01J 21/12; B01J 23/02; B01J 23/10; B01J 23/16; B01J 23/26; B01J 23/30; B01J 23/38; B01J 23/44; B01J 23/42; B01J 23/50; B01J 23/52; B01J 23/70

(52) U.S. Cl. 502/303; 502/325; 502/339; 502/344; 502/347; 502/304; 502/302; 502/306; 502/308; 502/309; 502/313; 502/317; 502/328; 502/332; 502/333; 502/334; 502/340; 502/348; 502/242; 502/243; 502/250; 502/252; 502/254; 502/255; 502/257; 502/261; 502/262; 502/326; 502/330

(57) ABSTRACT

A water gas shift catalyst comprising a precious metal deposited on a support, wherein the support is prepared from a mixture comprising a low surface area material, such as an aluminate, particularly a hexaaluminate, and a high surface area material, such as a mixed metal oxide, particularly a mixture of zirconia and ceria, to which may be added one or more of a high surface area transitional alumina, an alkali or alkaline earth metal dopant and an additional dopant selected from Ga, Nd, Pr, W, Ge, Au, Ag, Fe, oxides thereof and mixtures thereof.

The invention relates to water gas shift catalysts. More particularly, one embodiment of the invention relates to a water gas shift catalyst comprising a precious metal deposited upon a support, wherein the support is produced from a mixture of a low surface area material, such as an aluminate, and a high surface area material, such as a mixed metal oxide. A further embodiment adds various dopants and/or other additives to the catalyst and/or the support for the catalyst to enhance its performance.

### BACKGROUND OF INVENTION

Fuel cell power plants that utilize a fuel cell stack for producing electricity from a hydrocarbon fuel are well known. One example of these power plants is a low temperature fuel cell processing train, such as a proton exchange membrane fuel cell, which is suitable for use in a stationary application or in a vehicle, such as an automobile.

The hydrocarbon fuel for such fuel cell stacks can be derived from a number of conventional fuel sources, with preferred fuel sources including, but not limited to, natural gas, propane and LPG.

In order for the hydrocarbon fuel to be useful in the fuel cell stack, it must first be converted to a hydrogen rich fuel stream. After desulfurization, the hydrocarbon fuel stream typically flows through a reformer, wherein the fuel stream is converted into a hydrogen rich fuel stream. This converted fuel steam contains primarily hydrogen, carbon dioxide, water and carbon monoxide. The quantity of carbon monoxide can be fairly high, up to 15% or so.

Anode electrodes, which form part of the fuel cell stack, are adversely affected by high levels of carbon monoxide. Accordingly, it is necessary to reduce the quantity of carbon monoxide in the fuel stream prior to passing it to the fuel cell stack. Such reduction in the quantity of carbon monoxide is typically performed by passing the fuel stream through a water gas shift converter, and possibly other reactors, such as a selective oxidizer, prior to passing the fuel stream to the fuel cell stack. In addition to reducing the quantity of carbon monoxide in the fuel stream, water gas shift converters also increase the quantity of hydrogen in the fuel stream.

Water gas shift reactors are well known and typically contain an inlet for introducing the fuel stream containing carbon monoxide into a reaction chamber, a down stream outlet, and the catalytic reaction chamber, which is located between the inlet and outlet. The catalytic reaction chamber typically contains catalytic material for converting at least a portion of the carbon monoxide and water in the fuel stream into carbon dioxide and hydrogen. The water gas shift reaction is an exothermic reaction represented by the following formula:

CO+H₂O [symbol] CO₂+H₂.

There are a number of water gas shift catalysts that are known in the art. For instance, known water gas shift catalysts typically contain chromium, copper or noble metals placed on a support. In one preferred embodiment the noble metals comprise Pt and Re on a conventional support. Notwithstanding the existence of various catalysts for use in water gas shift converters, there is still a need for improvements in the performance of existing water gas shift catalysts, particularly in activity and stability at higher pressures and temperatures.

For example, various water gas shift catalysts work well at conventional temperatures and ambient pressures. However, these water gas shift catalysts frequently form high molecular weight hydrocarbons and by-products at higher pressures, for example, by means of a Fischer Tropsch synthesis reaction. For purposes of this disclosure, “high pressure” or “higher pressure” means pressures above 50 psi (3.4 bar).

In addition, when conventional water gas catalysts are modified to operate at higher pressures and to prevent the formation of such higher molecular weight hydrocarbons and by-products, activity of the catalysts is frequently reduced.

Accordingly, it is one object of one embodiment of the invention to provide an improved water gas shift catalyst that retains activity and selectivity, particularly at higher pressures.

It is the further object of one embodiment of the present invention to provide an improved water gas shift catalyst with increased stability over the lifetime of the catalyst.

It is a further object of one embodiment of the invention to utilize the improved catalyst in a process for the conversion of CO and H₂O to CO₂ and H₂, especially at higher pressures.

It is further object of one embodiment of the invention to provide a process for the preparation of these improved water gas shift catalysts.

It is understood that the forgoing detailed description is explanatory only and not restrictive of the invention.

### SUMMARY OF THE INVENTION

In accordance with one embodiment of the invention, there is provided an improved water gas shift catalyst comprising a precious metal deposited upon a support, wherein the support is produced from a mixture comprising a low surface area material, preferably an aluminate, and a high surface area material, preferably a mixed metal oxide.

A further embodiment of the invention comprises an improved water gas shift catalyst comprising a precious metal deposited upon a support, wherein the support is produced from a mixture comprising a low surface area material, preferably an aluminate, a high surface area material, preferably a mixed metal oxide and an alumina, preferably a transitional phase, high surface area alumina, more preferably a gamma alumina.

A further embodiment of the invention comprises an improved water gas shift catalyst comprising a precious metal deposited upon a support, wherein the support is produced from a mixture comprising a low surface area material, preferably an aluminate, a high surface area material, preferably a mixed metal oxide, and a transitional phase, high surface area alumina, preferably gamma alumina, wherein an alkali or alkaline earth metal dopant is added to the catalyst and/or the support.

A further embodiment of the invention comprises a water gas shift reaction whereby at least a portion of the carbon monoxide and water in a fuel stream is converted to hydrogen and carbon dioxide by utilization of catalyst comprising a precious metal deposited on a support, wherein the support is produced from a mixture of a low surface area material and a high surface area material.

A further embodiment of the invention comprises a process for the preparation of an improved water gas shift catalyst comprising preparing or selecting a support, wherein the support comprises a mixture of a low surface area material, preferably an aluminate, more preferably a hexaaluminate, and a high surface area material, preferably a mixed metal oxide, wherein the mixed metal oxide is selected from cerium oxide, zirconium oxide, titanium oxide, silicon oxide, neodymium oxide, praseodymium oxide, yttrium oxide, samarium oxide, lanthanum oxide, tungsten oxide, molybdenum oxide, calcium oxide, chromium oxide, magnesium oxide and mixtures thereof. In one preferred embodiment, at least two of these metal oxides are mixed to form the high surface area component of the support. In a more preferred embodiment, the mixed metal oxides comprise zirconia and ceria. Following preparation or selection of the support, a precious metal, preferably platinum, and preferably one or more dopants, more preferably an alkali or alkaline earth metal oxide, are deposited or impregnated on the support or the catalyst.

### BRIEF DESCRIPTION OF THE DRAWINGS

FIG. 1 is a graph illustrating the CO conversion percentage over time for two water gas shift catalysts operating at a pressure of 225 psig (15.5 bar) and a temperature of 350° C., wherein one catalyst contains Pt and Re on a support produced from a mixture of cerium oxide and zirconium oxide and the other catalyst has the same composition but without Re.

FIG. 2 is a graph comparing the CO conversion over time of several water gas shift catalysts, wherein the catalysts contain Pt on various compositions which form the support thereof, wherein the water gas shift reaction is conducted at a pressure of 225 psig (15.5 bar) and a temperature of 350° C.

FIG. 3 is a graph comparing the CO conversion over time of several water gas shift catalysts, wherein the catalysts contain Pt deposited on various compositions as the support, wherein an alkali metal dopant (either Na or K) is added to the composition of two of the catalysts and wherein the water gas shift reaction is conducted at a pressure of 225 psig (15.5 bar) and a temperature of 350° C.

### DETAILED DESCRIPTION OF AN EMBODIMENT OF THE INVENTION

The water gas shift catalyst of one embodiment comprises a precious metal deposited upon a support, wherein the support comprises a mixture of a low surface area material and a high surface area material.

For purposes of this disclosure, “low surface area” means less than 20 m²/g and preferably about 2-15 m²/g. In a preferred embodiment the low surface area material comprises an aluminate, preferably a hexaaluminate, wherein the cation for the hexaaluminate is selected from barium, calcium, potassium, manganese, magnesium, hafnium, scandium, zirconium, yttrium, cerium, lanthanum, praseodymium, neodymium, strontium and mixtures thereof. A particularly preferred hexaaluminate comprises barium hexaaluminate. Methods for preparing such hexaaluminates are known. Other preferred low surface area materials include various aluminates, preferably calcium aluminate, and various low surface area zirconium, titanium and aluminum compounds and mixtures thereof.

Combined with the low surface area material to form the support of the improved water gas shift catalyst is a high surface area material. For purposes of this disclosure “high surface area” means from about 80 to about 250 m²/g and preferably from about 80 to 200 m²/g.

One preferred high surface area material is a mixed metal oxide, which oxides may be selected from two or more of the following: zirconia, ceria, titania, silica, lanthana, praseodymium oxide, neodymium oxide, yttria, samarium oxide, tungsten oxide, molybdenum oxide, calcium oxide, chromium oxide, manganese oxide and magnesium oxide. One particularly preferred mixed metal oxide combination comprise zirconia and ceria with the preferred ratio of zirconia to ceria being about 1 to about 10 to about 10 to about 1. In another particularly preferred embodiment, praseodymia and/or neodymia are added to the ceria/zirconia support. The praseodymia and/or neodymia preferably comprises from about 3% to about 30% of the support, by weight. When both are present in the support, the ratio of the praseodymia to the neodymia is from 1 to 1 to about 3 to 1.

The mixed metal oxide portion of the support can be produced by blending together the metal oxides using conventional procedures or the mixed metal oxide component can be purchased from conventional sources separately or after combination of the separate metal oxides.

Alternatively, the high surface area material may comprise a promoted alumina, preferably gamma alumina, promoted with dopants including oxides selected from cerium, zirconium, lanthanum, yttrium, praseodymium, neodymium, samarium, tungsten, and molybdenum and the like and mixtures thereof. One particularly preferred high surface area material comprises gamma alumina promoted with ceria, lanthana and yttria.

In a further alternative embodiment, the high surface area material comprises a high surface ceria, titania, or silica and mixtures thereof.

To form the support, the low surface area material and the high surface area material are physically mixed by conventional procedures. Conventional liquids, such as water and acetic acid are preferably added to the mixture of solid materials to permit them to be processed, for example, by extrusion, to form extrudates or to form a slurry to be washcoated on a conventional honeycomb. The percentage of the high surface area material and low surface area material in the support ranges from about 10% to 90%, by weight. In one preferred embodiment, the low surface area material comprises about 20 to 40%, by weight, and the high surface area material comprises from about 80% to about 40% of the support, by weight. When additional components are added to the support, such as alumina or an alkali or alkaline earth metal dopant, the ratio of the low surface area material to the high surface area material is unchanged.

In an additional preferred embodiment, there is added to the mixture of the low surface area material and the high surface area material, up to about 40%, by weight, of an alumina. The preferred alumina is a transitional phase, high surface area alumina, more preferably a gamma alumina, with a surface area greater then about 200 m²/g. The alumina is blended with the low surface area material and the high surface area material to assist in binding the low surface area material and the high surface area material together. By use of the transitional phase, high surface area alumina, a support with improved mechanical stability, especially at higher temperatures, is produced. (The referenced “support” is the support for the precious metal and other dopants and does not refer to the use of a monolith or other such mechanical support used with a catalytic coating.)

In a further preferred embodiment, an alkali or alkaline earth metal oxide is added to the support as a dopant, preferably comprising from about 0.2 to about 10% by weight, and more preferably 1.0 to 1.5%, by weight of the support. In a preferred embodiment the dopant is an alkali metal oxide selected from sodium, potassium, cesium and rubidium and mixtures thereof with sodium and/or potassium oxides particularly preferred. When an alkali or alkaline earth metal dopant is added, it can be added to the support with the precious metal or it can be combined with the other components of the support at any stage in the processing of the support. The dopant can be added by conventional procedures, such as impregnation. In a preferred embodiment, the alkali or alkaline earth metal dopant is impregnated into the support after formulation of the support.

The precious metal which is deposited upon the support, comprising a low surface area material and a high surface area material, includes any of the precious metals, such as platinum, rhodium, rhenium, palladium, osmium, iridium, ruthenium and combinations thereof, and preferably platinum. In one particularly preferred embodiment, when the catalyst is used in a water gas shift reaction at higher pressures and temperatures above about 180° C., the precious metal is preferably only Pt and does not also include other precious metals, especially rhenium. While other precious metals can be used alone or in combination, the best performance for this preferred embodiment under these conditions is obtained by use of platinum alone. Fewer unwanted by products are produced when the catalyst contains only Pt. The quantity of the precious metal deposited upon the support is from about 0.01 to 5%, by weight, preferably from about 0.01 to about 1%, by weight.

In a further preferred embodiment, additional dopants are added to the catalyst with the precious metal, which dopants are selected from Ga, Nd, Pr, W, Ge, Au, Ag, and Fe, and their oxides and mixtures thereof, with Ga and Nd and their oxides preferred.

Once the support has been prepared, the precious metal, alkali or alkaline earth metal oxide dopant, and additional dopant, if desired, is deposited upon the support using conventional procedures, such as impregnation. In one preferred procedure the precious metal and dopants, if desired, are impregnated onto the support material in the form of a salt solution. For example, when the precious metal to be deposited is platinum, the support material is immersed in a platinum salt solution, such as tetra amine platinum hydroxide, and then dried and calcined at a temperature from about 350° to about 650° C. for about 1 to about 5 hours to transform the platinum salt to a platinum oxide. Depending upon the target loading, multiple impregnation steps may be needed.

After formation of the water gas shift catalyst, its surface area is preferably from about 30 to about 100 m²/g, more preferably from about 40 to about 80 m²/g.

The water gas shift catalyst of the preferred embodiments preferably is produced in the form of moldings, especially in the form of spheres, pellets, rings, tablets or extruded products, in which the later are formed mostly as solid or hollow objects in order to achieve higher geometric surfaces with a simultaneously low resistance to flow. Alternatively, monoliths coated with the catalytic materials are also preferred embodiments.

The catalyst is preferably employed in a process in which carbon monoxide and steam are converted to hydrogen and carbon dioxide at a temperature above 180° C., preferably above 250° C., more preferably above 350° C. and most preferably above 400° C. ranging up to about 550° C. and under pressures above ambient, preferably above about 50 psi (3.4 bar) more preferably above about 100 psi (6.9 bar), and most preferably above about 150 psi (10.3 bar) up to about 400 psi, (28 bar). In a preferred embodiment the carbon monoxide comprises from about 1 to about 15% of the feed stream and the molar ratio of the steam to the dry gas is from about 0.1 to about 5. It has surprisingly been discovered that there is significant improvement in CO conversion over the performance of conventional water gas shift catalysts when the catalysts of the disclosed embodiments are used, particularly at higher pressures and higher temperatures. In particular, there is a significant reduction or elimination of the production of undesirable high molecular weight hydrocarbons and by-products. Along with this reduction, high activity of the catalyst is retained.

In addition, while a person skilled in the art would have anticipated that the combination of a high surface area material and a low surface area material would yield a material with activity that was the weighted combination of the activity of the two materials, it has surprisingly been discovered the combination yields a higher than expected activity and enhanced stability over the life of the catalyst.

### EXAMPLES

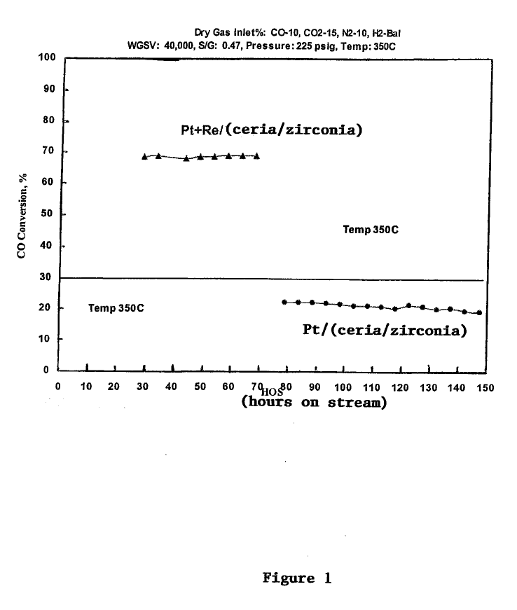

Catalysts in the form of either a monolith or extrusions are produced for use in a reactor. The conditions of the reactor are a dry gas inlet comprising 10% Co, 15% CO₂, 10% N₂, with the remaining amount comprising hydrogen. The temperature within the reactor is set at 350° C. The pressure is 225 psig (15.5 bar) with a DGSV of 27,200 l/hr, a wet gas space velocity of 40,000 l/hr and a S/G ratio of 0.47. The gas stream is passed over a catalyst bed containing 8 ccs of the catalyst under these conditions for various hours on stream. The time on stream is shown in FIGS. 1-3. The Figures disclose the CO conversion percentage over time for each catalyst tested.

### Example 1

A ceria/zirconia support is purchased from Rhodia comprising 80% ceria and 20% zirconia. Impregnated on this support is either 0.5% platinum in the form of platinum oxide, plus 0.5% rhenium in the form of rhenium oxide or 0.5% platinum alone. A water gas shift reaction for each catalyst is run at the stated conditions for the stated hours on stream. The catalyst containing platinum and rhenium exhibited a higher CO conversion than the catalyst containing only platinum on the ceria/zirconia support. Notwithstanding, the catalyst containing platinum and rhenium also produced significantly higher percentages of C₆ or higher hydrocarbons or wax, presumably by a Fisher Tropsch synthesis, at these higher pressures.

### Example 2

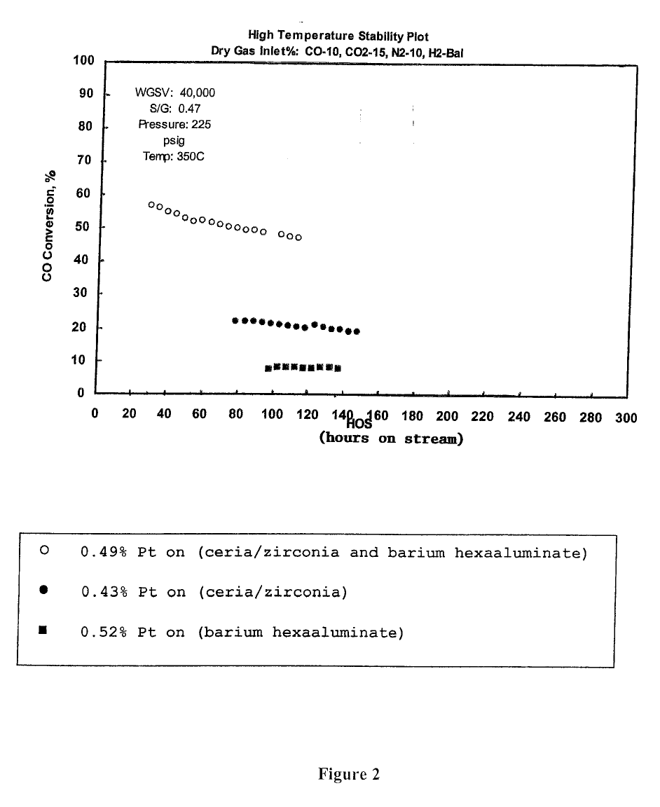

Three catalysts were prepared with differing supports: 1) 60% ceria/zirconia, ratio of ceria to zirconia 80:20, and 40% barium hexaaluminate, 2) 100% ceria/zirconia, ratio of ceria to zirconia 80:20, and 3) 100% barium hexaaluminate. Each catalyst was impregnated with from 0.43% to 0.52% platinum. The catalyst with the ceria/zirconia support contained 0.43% platinum, by weight. The catalyst with the barium hexaaluminate support contained 0.52% platinum, by weight. The catalyst with a blend of ceria/zirconia and barium hexaaluminate contained 0.49% platinum, by weight. A water gas shift reaction is run for the stated hours on stream at the conditions shown in FIG. 2 for each of the catalysts. The catalyst containing a support comprising a combination of ceria/zirconia and barium hexaaluminate exhibited a substantial conversion of CO, at least 20% greater than the catalyst containing only a ceria/zirconia support or a catalyst containing only a barium hexaaluminate support.

### Example 3

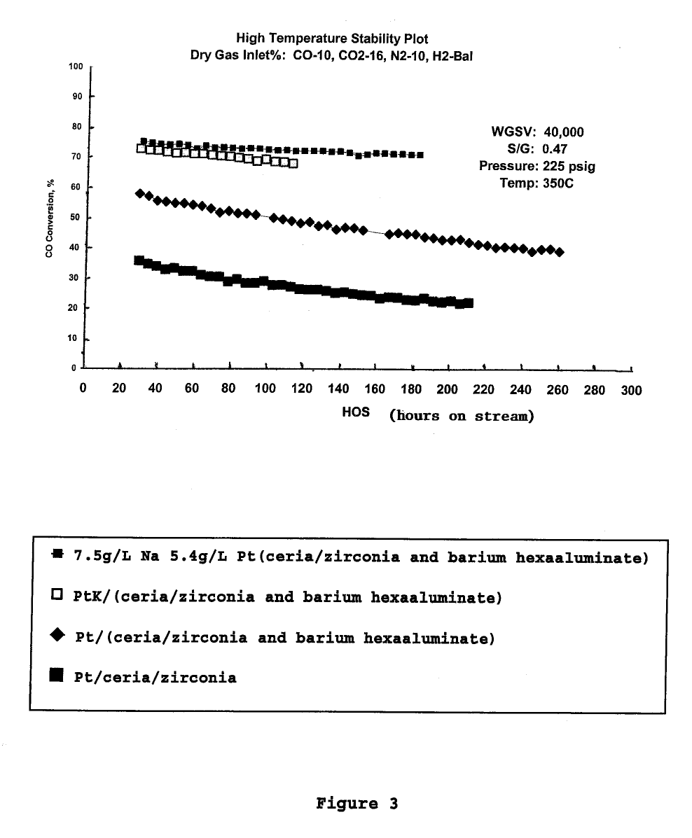

Various catalysts with various compositions are prepared, as shown in FIG. 3. The purpose of FIG. 3 is to show the impact of adding an alkali metal dopant to various catalysts. One catalyst contained 0.5% sodium and 0.5% platinum on a support comprising 60% ceria/zirconia (ratio: 80% ceria to 20% zirconia) and 40% barium hexaaluminate. Another catalyst contained 0.5% platinum on a support comprising 60% ceria/zirconia (ratio: 80% ceria to 20% zirconia) and 40% barium hexaaluminate to which has been added 0.5% potassium, by weight. In contrast to these two catalysts, a catalyst is prepared containing 0.5% platinum on a support comprising 60% ceria/zirconia (ratio: 80% ceria to 20% zirconia) and 40% barium hexaaluminate without any alkali or alkaline earth metal dopant. Another catalyst is prepared containing 0.5% platinum on a support comprising only 60% ceria and 40% zirconia. A water gas shift catalyst reaction is run for each catalyst at the stated conditions for the stated hours on stream. As is clear from FIG. 3, the conversion of CO is highest in catalysts containing an alkali metal dopant.

From this information it is clear that the catalysts utilizing a support prepared from a mixture comprising a high surface area material and a low surface area material produced a water gas shift catalyst with higher activity and stability even at higher pressures. In addition, the performance of these catalysts was enhanced by the addition of an alkali metal oxide as a dopant.

The inventors have also discovered that catalysts utilizing a support prepared from a mixture comprising a high surface area material and a low surface area material, when operated at higher pressures, produced little or no higher molecular weight hydrocarbons or by-products.

The inventors have also discovered that the performance of these catalysts may be improved by the addition of a high surface area transitional alumina, preferably gamma alumina, as an additional component of the support.

The inventors have also discovered that the performance of these catalysts may be further improved by impregnating the catalysts with dopants selected from Ga, Nd, Pr, W, Ge, Au, Fe and their oxides and mixtures thereof.

Although one or more embodiments of the invention have been described in detail, it is clearly understood that the descriptions are in no way to be taken as limitations. The scope of the invention can only be limited by the appended claims.

1. A water gas shift catalyst comprising a precious metal deposited on a support, wherein the support is prepared from a mixture comprising from about 10% to about 90% of a low surface area material with a surface area of less than about 20 m²/g and from about 10% to about 90% by weight of a high surface area material with a surface area from about 80 m²/g to about 300 m²/g.

2. The water gas shift catalyst of claim 1, wherein the support is prepared from a mixture comprising a low surface area aluminate or hexaaluminate and a high surface area mixed metal oxide, wherein the metal oxides are selected from the group consisting of two or more of the following: zirconia, ceria, lanthana, praseodymium oxide, neodymium oxide, yttria, titania, silica, samarium oxide, tungsten oxide, molybdenum oxide, calcium oxide, chromium oxide, magnesium oxide and mixtures thereof.

3. The water gas shift catalyst of claim 1, wherein the high surface area material comprises a transitional phase, high surface area promoted alumina, wherein the alumina is promoted with oxides selected from cerium, zirconium, lanthanum, yttrium, praseodymium, neodymium, samarium, tungsten, and molybdenum and mixtures thereof.

4. The water gas shift catalyst of claim 1, wherein the high surface area material is selected from the group consisting of high surface area titania, silica and mixtures thereof.

5. The water gas shift catalyst of claim 1, wherein the low surface area material comprises a hexaaluminate, wherein the cation of the hexaaluminate is selected from the group consisting of barium, magnesium, calcium, potassium, manganese, strontium, cerium, hafnium, scandium, zirconium, yttrium, praseodymium, neodymium, lanthanum, and mixtures thereof.

6. The water gas shift catalyst of claim 1, wherein the low surface area material comprises one or more materials selected from the group consisting of aluminates, a hexaaluminate selected from Ca, K, Ba, Sr, Mg, and Mn hexaaluminate and mixtures thereof, low surface area zirconia, titania, alumina, and mixtures thereof.

7. The water gas shift catalyst of claim 5, wherein the hexaaluminate comprises barium hexaaluminate.

8. The water gas shift catalyst of claim 1, wherein the precious metal is selected from the group consisting of platinum, palladium, rhenium, rhodium, ruthenium, iridium, osmium and mixtures thereof.

9. The water gas shift catalyst of claim 1, wherein the precious metal consists of platinum.

10. The water gas shift catalyst of claim 1, wherein the precious metal comprises from about 0.1 to about 5% of the catalyst, by weight.

11. The water gas shift catalyst of claim 2, wherein the mixed metal oxides comprise ceria and zirconia.

12. The water gas shift catalyst of claim 11 further comprising praseodymium oxide and/or neodymium oxide.

13. The water gas shift catalyst of claim 1 further comprising an alkali or alkaline earth metal dopant.

14. The water gas shift catalyst of claim 13, wherein the dopant is selected from the group of consisting of sodium, potassium, cesium, and rubidium oxides and mixtures thereof.

15. The water gas shift catalyst of claim 13, wherein the alkali or alkaline earth dopant comprises from about 0.2 to about 10% of the catalyst, by weight.

16. The water gas shift catalyst of claim 1, wherein the support further comprises up to about 40%, by weight, of a transitional alumina.

17. The water gas shift catalyst of claim 16, wherein the transitional alumina comprises gamma alumina.

18. The water gas shift catalyst of claim 1, wherein a dopant is added to the catalyst selected from the group consisting of Ga, Nd, Pr, W, Ge, Ag, Au, and Fe, their oxides and mixtures thereof.

19. A water gas shift catalyst comprising a precious metal deposited on a support, wherein the support is prepared from a mixture comprising from about 20 to about 40% of barium hexaaluminate and from about 80 to about 40% of a mixture of metal oxides comprising zirconia and ceria.

20. The catalyst of claim 19, wherein the mixed metal oxides further comprise praseodymium oxide and/or neodymium oxide.

21. The water gas shift catalyst of claim 19 further comprising an alkali or alkaline earth metal dopant.

22. The water gas shift catalyst of claim 19, wherein the support further comprises up to 40%, by weight, of a gamma alumina.

23. A water gas shift catalyst comprising platinum on a support, wherein the support is prepared from a mixture comprising barium hexaaluminate, a mixed metal oxide, up to 40%, by weight, gamma alumina and an alkali or alkaline earth metal dopant.

24. A water gas shift process comprising preparing a feed stream containing carbon monoxide and steam and passing that feed stream over a water gas shift catalyst comprising a precious metal deposited on a support, wherein the support is prepared from a mixture comprising from about 10% to about 90% of a low surface area material with a surface area of less than about 20 m²/g and from about 10% to about 90% by weight of a high surface area material with a surface area from about 80 m²/g to about 300 m²/g at a pressure above about 50 psi, (3.4 bar) and at a temperature above about 250° C.

25. The process of claim 24 wherein the quantity of carbon monoxide is between about 1 and 15% and the molar steam to dry gas ratio is from about 0.1 to about 5.
